(19) United States
(12) Patent Application Publication
(10) Pub. No.: US 2013/0290289 A1
(43) Pub. Date: Oct. 31, 2013

(54) INTEGRATION OF THIRD PARTY INFORMATION

(71) Applicant: BRIGHTEDGE TECHNOLOGIES, INC., San Mateo, CA (US)

(72) Inventors: Sammy YU, San Mateo, CA (US); Jimmy YU, Foster City, CA (US); Lemuel S. PARK, Cerritos, CA (US); Joshua Philip CROSSMAN, Los Altos, CA (US); Thomas J. ZIOLA, Menlo Park, CA (US)

(73) Assignee: BRIGHTEDGE TECHNOLOGIES, INC., San Mateo, CA (US)

(21) Appl. No.: 13/874,472

(22) Filed: Apr. 30, 2013

Related U.S. Application Data
(60) Provisional application No. 61/640,706, filed on Apr. 30, 2012.
(60) Provisional application No. 61/769,186, filed on Feb. 25, 2013.

(51) Int. Cl. G06F 17/30

(52) U.S. Cl. CPC G06F 17/30867
USPC 707/706

(57) ABSTRACT

An example embodiment may include a method of managing digital content. The method may include selecting third party digital content. The third party digital content may reside in a third party system or be controlled by the third party system. The method may further include collecting search engine optimization (SEO) data associated with the third party digital content. The method may also include defining an SEO policy to generate recommendations regarding the third party digital content based on the SEO data. The method may also include analyzing the third party digital content by applying the SEO policy to the SEO data to generate one or more recommendations regarding the third party digital content.

### CROSS-REFERENCE TO RELATED APPLICATIONS

This patent application claims the benefit of and priority to U.S. Provisional Patent Application No. 61/640,706, filed Apr. 30, 2012 and to U.S. Provisional Patent Application No. 61/769,186 filed Feb. 25, 2013. The foregoing applications are incorporated herein by reference.

### TECHNICAL FIELD

Technologies described herein are related generally to content management systems, search engine optimization (SEO) systems, social media and information exchanged over the Internet.

### BACKGROUND

Unless otherwise indicated herein, the subject matter described herein are not prior art to the claims in the present application and are not admitted to be prior art by inclusion in this section.

In the digital marketing industry, organic (i.e., un-paid) searches are the primary focus of search engine optimization (SEO). Additionally, organic searches represent a large percentage of all search traffic. Consequently, a large percentage of on-line traffic, conversion events, and on-line revenue may be generated due to organic searches. Furthermore, social media may influence search results and search traffic. Social media also represents a rapidly emerging channel through which an audience may be reached by a commercial entity. Because a large percentage of Internet marketing is represented by organic searches and the emerging presence of the social media, digital marketing and particularly SEO may be affected.

For example, some SEO systems, which generally operate to achieve improved search results for commercial entities, have operated independently of other commercial entity systems, such as content management system (CMS) or a social media publishing system. However, the independence of SEO systems with respect to other commercial entity systems may fail to meet the needs and demands of the commercial entities due to the pace at which information is available and becomes important to SEO and overall on-line marketing performance of the commercial entity.

Additionally, the commercial entity systems may include two or more separate commercial entity content teams within the commercial entity. For example, a commercial entity may include a social media team, a CMS team, a SEO team, etc. The commercial entity content teams may not interact regularly enough to effectively operate and manage the SEO for the commercial entity. Infrequent interactions between the commercial entity content teams is especially detrimental as best practices of the SEO industry evolve and as search engine algorithms change at an ever-increasing rate. To accommodate for the changes in the best practices and the search engine algorithms, some commercial entities implement repeated training programs, non-scalable and sometimes manual checking of SEO effectiveness, and multiple interactions between the commercial entity content teams. The training, checking of SEO effectiveness, and the multiple interactions introduce inefficiencies into the commercial entity. In addition, opportunities to improve the SEO or other online performance metrics may not be efficiently passed through to other systems in a timely manner, or otherwise automated or integrated into the workflow systems and task processing and management systems typically used by content teams that directly create and edit content.

Furthermore, coordination of changes to content to improve SEO performance and online conversion and purchase intent performance across the commercial entity content teams may introduce difficulty. Priorities and efforts of each of the commercial entity content teams may not be coordinated and may introduce a complex administrative and managerial effort into the commercial entity. Significant human resources and capital resources may be devoted to coordination and training. Oftentimes, most commercial entity digital content does not comply with internal SEO policies and only a limited fraction of web pages on a web site of the commercial entity are optimized. Consequently, significant business and marketing opportunities are delayed or never achieved.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Technologies described herein relate generally to an example method of managing digital content. The method may include selecting third party digital content. The third party digital content may reside in a third party system or be controlled by the third party system. The method may further include collecting search engine optimization (SEO) data associated with the third party digital content. The method may also include defining an SEO policy to generate recommendations regarding the third party digital content based on the SEO data. The method may also include analyzing the third party digital content by applying the SEO policy to the SEO data to generate one or more recommendations regarding the third party digital content.

These and other aspects of example embodiments of the invention will become more fully apparent from the following description and appended claims.

### BRIEF DESCRIPTION OF THE DRAWINGS

To further clarify various aspects of some embodiments of the present invention, a more particular description will be rendered by reference to specific embodiments that are illustrated in the appended drawings. It is appreciated that these drawings depict only embodiments of the invention and are therefore not to be considered limiting of its scope. The embodiments will be described and explained with additional specificity and detail through the use of the accompanying drawings:

FIG. 1 illustrates an example embodiment of an SEO system;

FIG. 2 illustrates an example system including the SEO system of FIG. 1 integrated with third party systems;

FIG. 3 illustrates an example method of managing digital content; and

FIG. 4 illustrates an embodiment of a computing system that can implement some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, may be arranged, substituted, combined, separated, and designed in a wide variety of different configurations, all of which are explicitly contemplated herein.

Search engine optimization (SEO) systems, content management systems (CMS), and social network systems may not be presently integrated. The lack of integration results in a failure to achieve rapid scalability across an organization, such as a commercial entity (herein referred to as a “third party”).

Opportunities exist to improved digital marketing results through integration of SEO systems with third party systems. Through integration of the SEO system with the third party systems (e.g., a CMS of the third party or a social network system of the third party) information may be exchanged, which may increase operational efficiencies, improve targeting of content to desired audiences, or increase the impact of content on purchase or conversion intent of desired audiences. For example, integration between the SEO system and the third party systems may reduce down time, reduce implementation complexity, improve management oversight, and reduce execution costs.

Generally, some of the disclosed embodiments relate to a method of managing digital content. In particular, some embodiments relate to SEO in the context of managing third party digital content as well as technologies included in an SEO system that provides SEO analytics regarding management of third party digital content. The SEO system may be integrated with the third party system. The SEO system may, by virtue of integration, inform the third party system, direct the third party system, provide recommendations to the third party system, enable execution of recommendations within the third party system, enable execution of recommendations on behalf of the third party system, or some combination thereof. In some embodiments, the third party system may include a CMS system, a web analytics system, a social media network, a social media publishing system, a social media analytics and metrics system, an associated paid media system, a reputation management tracking system, or a backlink tracking or management system. The third party system may further include interfaces between the third party systems and the SEO system. By integrating the SEO system with the third party system, the third party digital content may be optimized to achieve desired financial, search performance, and optimization results.

The integration between the SEO system and the third party systems may be two-way. For instance, the integration may result in communication of information to the SEO system from the third party system and/or to the third party system from the SEO system. Additionally, information may be further directed from a first third party system to another third party system through the intermediation by the SEO system or one or more network interfaces created by multiple integrations from the SEO system and one or more third party systems.

Another example embodiment may include a method of managing digital content. The method may include selecting third party digital content. The third party digital content may reside in a third party system or may be controlled by the third party system. The method may further include collecting SEO data associated with the third party digital content. The method may also include defining an SEO policy to generate recommendations regarding the third party digital content based on the SEO data. The method may also include analyzing the third party digital content by applying the SEO policy to the SEO data to generate one or more recommendations regarding the third party digital content.

Reference will now be made to the figures wherein like structures will be provided with like reference designations. It is understood that the figures are diagrammatic and schematic representations of some embodiments and are not limiting of the present invention, nor are they necessarily drawn to scale.

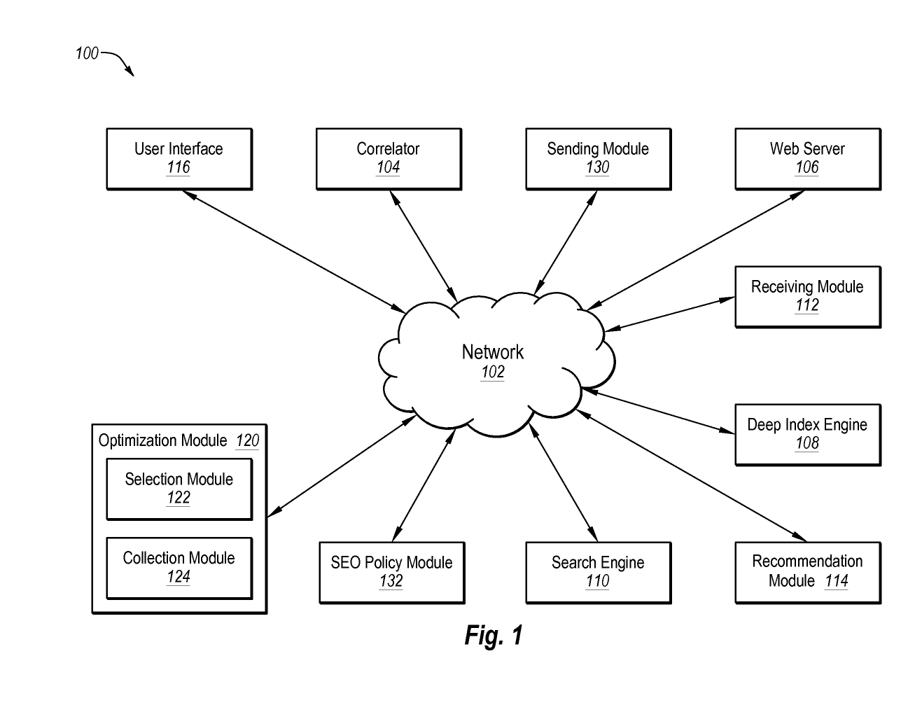

FIG. 1 illustrates an example embodiment of an SEO system 100 configured to be integrated with a third party system, according to some embodiments described herein. In some embodiments, the SEO system 100 may provide SEO data, integrated external data, search or social metrics, and recommendations to a third party for integration into a third party system. The third party system may be operated, managed, owned, and/or controlled by the third party. For example, the third party system may include a CMS and the SEO system 100 may provide SEO data, integrated external data, and recommendations to the CMS. The SEO data, integrated data, and recommendations may be regarding digital content such as a web site managed by the CMS.

In some embodiments, the SEO system 100 may include a network 102, which may connect the various parts of the SEO system 100 to one another. For example, in this and other embodiments, the network 102 connects a web server 106, a deep index engine 108, a correlator 104, a search engine 110, an optimization module 120 that may include a selection module 122 and a collection module 124, a sending module 130, a recommendation module 114, a receiving module 112, and a user interface 116. It will be appreciated that while these are shown as separate, the components may be combined as desired. Further, while one of each component is illustrated, the SEO system 100 may optionally include more than one of each of the illustrated components.

In some embodiments, the network 102 may include the Internet, including a global internet work formed by logical and physical connections between multiple wide area networks and/or local area networks and may optionally include the World Wide Web (“web”), including a system of interlinked hypertext documents accessed via the Internet. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network. A user of the network 102 may access digital content on the network 102, including but not limited to, web pages, web sites, social media sites, blogs, emails, videos, and other forms of media.

The web server 106 may include any system capable of storing and/or transmitting digital content. The web server 106 may provide access to web pages of a web site or other digital content via the network 102. The digital content stored and/or transmitted by the web server 106 may be analyzed for SEO or to generate one or more recommendations pertaining thereto. The web server 106 may further communicate data to the SEO system 100 to incorporate and/or subsequently process.

Digital content may include any number of discrete digital items that may be linked or otherwise associated. For example, a web site may have multiple web pages that are linked with the web site. The aggregation of visits or estimation of such visits to digital content may be referred to as traffic. Digital content as used herein refers to any online posting, including domains, subdomains, web posts, Uniform Resource Identifiers (URI), Uniform Resource Locators (URL), images, videos, non-permanent postings such as e-mail and chat unless otherwise specified. Digital content may further include any discrete digital item that may be associated with other digital items and may or may not be published online. For example, digital content may include web sites and/or web pages that are in testing phases, development phases, prior to being published, prior to access by users, etc. Digital content may further include user reviews, social media preferences, social media messages, social media posts, social medial videos, and other content posted in on a social media platform such as Facebook, Twitter, Pinterest, Linked In, Foursquare, etc. Digital content may be associated with an entity, which may be any business, corporation, partnerships, collaboration, foundation, individual, or other person or groups of people, that own, have interest in, or may be otherwise affiliated with the digital content. Generally, the entity associated with digital content is referred to herein as a third party.

The digital content may further include SEO objects. The SEO objects may be any portion of the digital content, another digital object or information or related data about the content that may be used in SEO. For example, search terms, sometimes referred to as keywords; web pages; social media pages; blogs; backlinks; social media posts; social media promotions; digital items and templates existing within a third party system; items and templates generated by the third party system, and items and templates linked to the third party system are some examples of SEO objects. Generally, as used herein, the terms “items,” “SEO objects,” and “digital content” may overlap. Accordingly, in some circumstances a single article may properly be described as an item, an SEO object, digital content, or some combination thereof. For instance, a blog may be referred to as an SEO object or digital content. The blog may include one or more keywords that may be referred to as an item but may also be categorized as an SEO object.

The deep index engine 108 may be configured to use the SEO objects to collect SEO data associated with the SEO object and/or digital content. For example, when the SEO object is a search term, the deep index engine 108 may perform a search of the network 102 using the search term to produce search results and identify references to a third party within the search results. To identify references to the third party, the deep index engine 108 may be configured to crawl the search results. In particular, the deep index engine 108 may be configured to crawl the search results and analyze SEO data associated with the crawl. For example, the deep index engine 108 may determine on-page information and backlink data for each reference in the search results.

A deep index engine 108 according to some embodiments is described in more detail in copending U.S. Pat. No. 8,190,594 entitled COLLECTING AND SCORING ONLINE REFERENCES, issued May 29, 2012, which is hereby incorporated by reference in its entirety.

The correlator 104 may be configured to collect SEO data associated with the SEO object and/or digital content. For example, when the digital content is a web page, the correlator 104 may determine how many visitors are directed to the web page resulting from a search using a specific search term, an SEO rank of the digital content based on a specific search term, estimate a total number of visitors to the digital content, etc. Alternately or additionally, the correlator 104 may determine the number of conversions on a web page resulting from a search using a specific search term. Alternately or additionally, the correlator 104 may determine a network traffic history of a user in relation to digital content. The network traffic history of a user may include, but is not limited to search terms searched in a search engine (e.g., the search engine 110) that resulted in visits to the digital content; conversions on the digital content; links (e.g., in social media or articles) that directed the user to the digital content; duration the user stayed on the digital content; actions performed on the digital content; usage patterns of the user or a group including the user; preferences of the user; information requested by a user; an agreement by a user to receive additional information; network preferences of the user; other sites visited by the user; and a social media participated in by the user.

A correlator 104 according to some embodiments is described in more detail in co-pending U.S. patent application Ser. No. 12/574,069, filed Oct. 6, 2009 entitled CORRELATING WEB PAGE VISITS AND CONVERSIONS WITH EXTERNAL REFERENCES, which application is hereby incorporated by reference in its entirety.

The search engine 110 may be an internal search engine or private search engine that may be configured to produce search results. The search results may include non-category specific search results, such as web sites. Additionally, the search results may include category specific search results, such as images, videos, news, shopping, blogs, books, places, discussions, recipes, patents, calculators, stocks, timelines, etc. The search engine 110 may also be a public search engine or commercial search engine, such as those search engines of Bing, Google, Yahoo, or the like.

In some embodiments, the search engine 110 may be configured to provide the search volume of a specific search term that may be evaluated for inclusion in digital content. Alternately or additionally, the search engine 110 may be configured to provide a paid search value of a search term or data related to the paid search value. For example, in some embodiments, the search engine 110 may provide an average value of a cost-per-click advertisement associated with a specific search term. Additionally or alternatively, the search engine 110 may provide a value of costs-per-click advertisements associated with a search term for every entity or a subset of the entities that produce the costs-per-click advertisements.

The receiving module 112 may be configured to receive external data associated with an SEO object or digital content. For example, the digital content may be a web page associated with a third party. The external data associated with the web page may include information regarding the network traffic history of a user; information regarding presentations of items on the digital content to a particular user; on a particular device, in a particular location, or based on other objectives or results; and information regarding social communications of the user or groups of users regarding digital content.

The information regarding social communications of the user or groups of users may include, the social media that is used for the social communications, the topic of the social communications, the text or images or other media in the communication, the frequency and/or length of the social media communications, the tone of the social communications, the number of views of the social communications, the indications of level of influence on or connectivity of the user with other users of the social media, among other information.

In these and other embodiments, the external data may be sourced directly from a social media network. For example, the external data may be sourced via an API, from an analysis of the SEO object, or from an external data provider that collects and consolidates social media analytic data and social media metrics from social media platforms.

The receiving module 112 may receive the external data from outside the SEO system 100. For example, as mentioned above an external data provider may collect the external data and communicate the external data to the SEO system 100. More specifically, the external data provider system may communicate the external data to the receiving module 112 of the SEO system 100.

For example, in some embodiments, when the SEO object is a web site and an external data provider system controlled by an entity associated with the web site may provide the external data. In these and other embodiments, the entity may control the web site and/or the entity may have designed the web site for a secondary entity. In these and other embodiments, the external data provider system may be a CMS associated with the entity. The CMS may provide or manage digital content that may be included on the web site or may manage workflow associated the process of selecting, prioritizing, and authoring digital content for and recommendations regarding the web site and structuring the web site to achieve optimal financial and operational goals. The external data provider system may also be other types of systems that are configured to collect and provide one or more of the different types of external data.

In some embodiments, the external data may be received by the receiving module 112 from other sources that interface with a CMS. The other sources may provide the external data to the CMS, which may provide the external data to the receiving module 112. The CMS may generally enable content teams, authors, editors, or contributors to select create, edit, target, or otherwise manage digital content intended to be displayed to users.

The optimization module 120 may be configured to operably couple and orchestrate work performed by the correlator 104, the web server 106, the deep index engine 108, the search engine 110, the receiving module 112, the recommendation module 114, and the user interface 116.

The optimization module 120 may include various modules for implementing particular functionalities. In some embodiments, the optimization module 120 may be generic to and include a selection module 122 and a collecting module 124. The selection module 122 and the collecting module 124 may communicate with, receive data from, and/or send data to one or more of the correlator 104, the web server 106, the deep index engine 108, the search engine 110, the receiving module 112, the recommendation module 114, and the user interface 116 to implement one or more particular functionalities.

In some embodiments, the selection module 122 may be configured to select one or more SEO objects or the digital content associated with a third party. For example, the selection module 122 may select a web page or web site as the digital content. Additionally, the selection module 122 may be configured to select digital content that may be provided to the selection module 122 by a CMS or another third party system, for instance.

In some embodiments, the collecting module 124 may be configured to collect SEO data associated with the selected SEO object or the selected digital content. In some embodiments, the SEO data may include signals that include information about the selected SEO object or the selected digital content. The collecting module 124 may coordinate with the web server 106, the deep index engine 108, the search engine 110, and/or the correlator 104 to collect SEO data associated with the SEO object or the selected digital content.

For example, the selected digital content may be digital content provided by a CMS for a published web page. In these and other embodiments, the search engine 110 may search for the digital content in a particular channel and produce search results related to the digital content. The deep index engine 108 may crawl the search results to identify one or more references to the digital entity. The deep index engine 108 may also evaluate signals related to the digital content. The signals may contain information about the reference to the digital content. For example, the signals may contain information such as, the search volume directed to the digital content, the location of the reference to the digital content in the search results (i.e., the rank of the reference in the search results), a description of the digital content, a cost for a cost-per-click campaign to direct a given audience to the digital content, among others.

Additionally, in these and other embodiments, the correlator 104 may correlate visits and/or conversions to the web site by a user with an external reference that directed the user to the web site. The SEO system 100 may collect other types of SEO data as discussed, illustrated, and/or contemplated in U.S. Pat. No. 8,190,594 and co-pending U.S. patent application Ser. No. 12/574,069 discussed elsewhere herein.

The recommendation module 114 may be configured to integrate the SEO data, the external data, and the digital content. The recommendation module 114 may then normalize and/or prioritize the SEO data, the external data, and the digital content. Once prioritized, the recommendation module 114 may be further configured to generate one or more recommendations that may optimize the digital content in view of the SEO data and/or the external data or otherwise indicate whether SEO policies have been achieved with respect to the digital content. For instance, the recommendations may allow informed choices about allocation and focus of resources for maximum SEO performance of the digital content or other business and operational goals such as conversion and purchase intent by intended audiences.

The recommendation module 114 also may enable customization of the recommendations. For example, the recommendation module 114 may enable a user to edit, override, or reset, a recommendation to better match policies of a third party. Additionally, the customization of the recommendations may enable recommendations to apply differently to certain web pages, groups of web pages across a web site, web pages across multiple web sites, web pages across a domain, sub-domains, and micro-web sites, etc. such that the recommendations correspond to a management style or goal of a company.

The recommendations and/or analyses generating the recommendations may be applied to one or more portions of the digital content. For example, a third party having a large web site including thousands of web pages may apply the analyses generating the recommendations to a certain portion of the web site that is changing or under construction, for instance.

Additionally or alternatively, a first portion of the digital content may be analyzed at a first frequency and a second portion of the digital content may be analyzed at a second frequency. For example, a company having a large web site may continuously analyze a portion of the web site including sales while periodically analyze the remainder of the web site. Additionally or alternatively, analysis of high-volume landing pages may be analyzed at a first frequency, and lesser-volume pages analyzed at a second frequency.

In some embodiments, the recommendation module 114 may be configured as a centralized policy management and compliance system. The centralized policy management and compliance system may include multiple SEO policies based upon which recommendations are generated, which pages are impacted, which parts of a web site are being analyzed, and differently from one content team, business unit, domain, sub-domain, or from one content authoring environment to another. The SEO policies may be set organizationally or machine-learned for one or more web sites, sub-web site, domains, sub-domains, etc. and customized for each differentially, based on criteria established and managed centrally or by distinct teams, in accordance with corporate policies established by the web site owner, operator, or manager. For example, for an administrator of multiple distinct third parties, the recommendation module 114 may enable customizations across each site, domain, and sub-domain, etc. that are managed by the administrator.

In some embodiments, the recommendation module 114 may prioritize SEO data, the external data, digital content, and the recommendations based on parameters. The parameters may be received from a user or a third party, for instance. The parameters may include, but are not limited to, a time frame in which the recommendations may be accomplished, an indication of a return on investment, an increase or a decrease in revenue, a location, an audience, a marketing object. The marketing object may include increasing visits to the digital content, increasing the views and/or downloads of the digital content, increasing a number of email addresses collected for a marketing campaign using the digital content, increasing a number of users that subscribe to updates through media related to the digital content. In some embodiments, more than one parameter may be included in the recommendation module 114. For example, the parameters may include prioritizing the recommendations based on a location achieves the greatest return on investment and increasing revenue by more than a predetermined threshold. In addition, the parameters may be established by a mathematical algorithm that combines and weighs various factors associated with the digital content, structural aspects web sites, industry or social media trends, competitive factors, etc

When parameters are included in the recommendation module 114, the receiving module 112 may receive signals about the digital content related to the parameters. Additionally, the collecting module 124 may collect signals regarding the digital content related to the parameter. The recommendation module 114 may normalize and/or assign weights to each of the signals (i.e., the signals collected by the collecting module 124 and signals received by the receiving module 112) and perform an analysis on the signals to generate one or more recommendations regarding the digital content.

The recommendation module 114 may produce multiple types of recommendations. The recommendations may include factors that may appear “on-page” as well as factors that may appear “off-page.” The recommendations may be relevant to a portion of the digital content or may be relevant to multiple portions of the digital content.

For example, the recommendations may include identifying an SEO object to generate or publish in the digital content; identifying when or how to generate an SEO object in the digital content; identifying when or how to publish an SEO object in the digital content; identifying where to publish an SEO object in the digital content; identifying which SEO objects are trending in which social media channels or on a network related to the digital content; identifying which SEO objects are valuable in which social media channels or on a network related to the digital content; determining an impact of an SEO object on search volume directed towards the digital content, search traffic directed towards the digital content, or web analytics metrics directed towards the digital content; suggesting a choice about which SEO objects to focus a campaign involving the digital content for maximum SEO; determining a way to optimize a campaign of involving the digital content for multiple keywords; producing a backlink to the digital content; changing items of the digital content; changing a tag within the digital content; using items for the digital content related to a certain demographic; searching at a predetermined frequency for a keyword that leads users to the digital content; identifying a change to layout of the digital content; identifying a change of a code-to-text ratio of the digital content; suggesting a change to a presence of images in the digital content; identifying an alternative tag to include in the digital content; identifying duplicate items on various digital content; identifying competitive information related to the digital content; identifying keyword optimizations for the digital content; identifying keyword-page associations for the digital content; and identifying web site priorities for certain keyword-page associations of one type over other keyword page associations included in the digital content.

In some embodiments, the recommendation module 114 may generate real-time or near real-time recommendations. For example, the collecting module 124 may collect real-time signals regarding digital content. Based on the real-time signals, the recommendation module 114 may recommend a change in the digital content or may identify an error in the digital content. A third party system may implement the change to the digital content in real-time. Furthermore, the recommendations may be delivered immediately to a user, allowing for real-time or near-real-time feedback on the recommendations, the filters, and/or results from execution of the recommendations.

In some embodiments, the recommendation module 114 may generate recommendations based on changing trends in SEO objects. For example, a changing rank of a web site for certain keywords, the search volume for the keywords, the traffic on the web site generated for the keywords, the keywords appearance in social media, the change in behavior of a user on the web site that enters the web site having searched for the keywords, among other keyword trends, may cause the recommendation module 114 to recommend a change in the digital content. For example, the recommendation module 114 may recommend use of digital content related to a certain demographic based on the trend of the certain demographic searching more often for a keyword that leads users to the digital content.

In some embodiments, a third party system such as a CMS may send information to the receiving module 112. The recommendation module 114 may use the information, such as SEO data or external data, to generate recommendations. For example, the information may include items on a web site that are correlated with sales of certain products on the web site and traffic to the web site. Based on the information and SEO data collected through the collecting module 124, the recommendation module 114 may generate recommendations for SEO of the web site.

The recommendations may apply to a single web page or groups of web pages, as selected by a user or by a third party, for instance. In addition, in some implementations a user interface 116 may include a single “button” that the user selects to trigger an analysis of the digital content or some portion thereof and to trigger generation of the recommendations for the digital content. Additionally or alternatively, the button may be included on a third party system such as a CMS and/or an analysis of the digital content may be triggered automatically by a third party system. For example, at a certain point in development of the digital content, such as when the digital content is published, an analysis may be automatically triggered.

Additionally or alternatively, the recommendations may be triggered automatically as described above or through one or more alternative mechanisms in a third party system; through selection of an object shown on-screen in a drop-down menu, which may be included in the user interface 116 (described below) for instance; or through selection of an on-screen recommendation button being a selectable feature in the third party system.

In some implementations, during development of the digital content an analysis may be automatically and/or manually (i.e., through selection of a button) triggered one or more times. For example, upon completion of the digital content an analysis may be automatically triggered. The recommendations periodically generated during development of the digital content may enable a better-optimized final version of the digital content.

In addition, the recommendation module 114 may be configured to record data about recommendations, findings, errors, etc. The recorded data may be collected to provide an automated and/or customizable report. The reports may be provided according to a template in some embodiments. The reports may pertain to the SEO system 100, users of the SEO system 100, recommendations, execution of recommendations, SEO results of the recommendations, etc. For example, the reports may include which web pages or other portions of digital content a user checked and when, what recommendations were generated, and which recommendations were executed for which portions of the digital content, which individuals or groups executed recommendations, when the recommendations were executed, etc.

The reports may have discrete results, which may be organized item-by-item, across a type of item, across a portion of digital content, or across an entire example of digital content. Additionally, the reports may include scores (i.e., a level of optimization) for an item, a portion of digital content, an entire example of digital content or for social content on digital content. In some embodiments, the reports may be used in digital content production management. For example, execution of recommendations may be controlled and sequenced. Actions of separate teams may be coordinated, etc.

Additionally or alternatively, the recommendation module 114 may enable a user to “score” or otherwise assess the effectiveness and quality of the SEO of digital content. The score may reflect a level of optimizations of the digital content, for instance. The score may occur automatically in some embodiments. Additionally, the recommendation module 114 may enable prioritization of the recommendations according to the score.

In some embodiments, the recommendation module 114 may be configured to produce a digital content template or generate one or more recommendations according to a third party system template. The digital content template may include or otherwise embody one or more of the recommendations regarding the digital content analyzed by the recommendation module 114. In these and other embodiments, the recommendation module 114 may indicate to a third party system, such as a CMS, through the sending module 130 a type of digital content template that may be created based on the recommendations for SEO. The recommendation module 114 may additionally or alternatively recommend subject matter to include in a digital content template of the third party based on the SEO.

For example, the collecting module 124 may collect signals related to a keyword for which a web site does not appear in search results (or does not appear in top search results). The third party operating the web site may perceive it to be advantageous for the web site to appear as a result of a search based on the keyword. The collecting module 124 may send the information to the recommendation module 114. The recommendation module 114, through the sending module 130, may communicate with a CMS that manages the web site and enable the generation of a web page for the web site aimed at allowing the web page to perform better in search results. The recommendation module 114 may send information for producing the web page to the CMS. The information may include a type of web page template to use for the web page being created. The information may also include subject matter to include in the web page, such as specific or general items, other related keywords, backlinks to other web pages, backlinks to other web sites, links to social media sites, content from a content store, content from a social media source, paid adverting depending on performance, etc.

The recommendation module 114 may be configured to include actual or estimated financial or optimization results (generally, “SEO results”) of executing one or more of the recommendations to generate additional recommendations. The SEO results may include, but are not limited to, an estimated revenue, an actual revenue, estimated return on investment, actual return on investment, an estimated duration to achieve a parameter (discussed above), or an actual duration to achieve a parameter.

The recommendation module 114 may be configured to track SEO data collected by the correlator 104. Some examples of the SEO data collected by the correlator 104 may include, but is not limited to, search performance, visits/traffic, conversions, revenue, and engagement metrics, such as likes, dislikes, referrals, posts, re-posts, reviews, end-user rankings, mention velocities, mentions. In some embodiments, the recommendation module 114 may then report the SEO data to a user. Reporting the SEO data to the user may enable the user to understand one or more SEO results achieved (or not achieved) from execution of recommendations regarding the digital content. In some embodiments, the recommendations may be delivered via an API into a third party system that allows the recommendations to be displayed on an overlay of digital content communicated to the recommendation module 114 for analysis. The recommendations may be displayed over the digital content to illustrate the recommendations. Additionally or alternatively, the recommendations may be displayed via an application plug-in, an independent application, or an application embedded in another application.

In some embodiments, the recommendation module 114 may be configured to review the digital content based on SEO data collected by the collecting module 124, based on filters, based on one or more recommendations, based on input received through the user interface 116, or some combination thereof. The filters and/or the recommendations applied by the recommendation module 114 to the digital content may vary based on the type of digital content and may vary within portions of the digital content. For example, when the digital content includes a web site with multiple web pages, the recommendation module 114 may review a subset of the web pages reviewing specifically for one or more particular items or SEO objects and may review a second subset of the web pages, reviewing specifically for other items or other SEO objects.

The user interface 116 may enable a user to customize the filters and/or the recommendations applied by the recommendation module 114, applied to specific digital content, and/or applied to specific types of digital content. When incorporated in a system that integrates a third party system with the SEO system 100, customization of the filters and the recommendations may allow for flexibility in generating and reviewing digital content. The flexibility may further enable generation and review of digital content under filters and recommendations specifically customized for the digital content. Thus, digital content may be reviewed by one or more customized filters based on a domain, a sub-domain, whether the digital content is a web site, an intended SEO result, etc.

The review may include an audit of digital content. The digital content that is audited may include a web site including multiple pages which is continuously or periodically audited for recommendations. Additionally or alternatively, the recommendation module 114 may enable selection of a portion of the digital content to periodically or continuously audited. A selected portion may be audited while another portion may be excluded from audit.

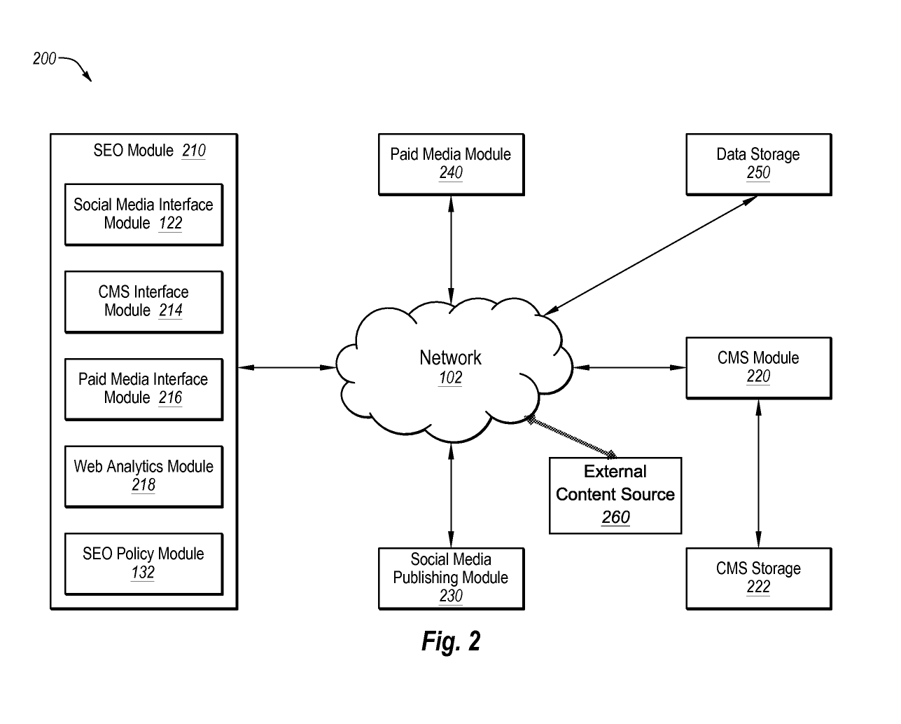

In some embodiments, the customization may occur at an SEO policy module 132. Generally, the SEO policy module 132 may enable definition of multiple, customizable SEO policies applied to the digital content during a review and/or analysis. For example, an SEO policy may include a setting that may provide a preference of certain keyword-page pairings over other keyword-page pairings. The preference may be applicable in a third party such as a corporation with multiple content teams that compete internally for targeting certain keywords within web site under control of individual content teams. Furthermore, the multiple SEO policies may be consolidated into a centralized SEO policy management system. Some additional details of the SEO policy module 132 are below with reference to FIG. 2.

In some embodiment, the recommendation module 114 may be configured to review the digital content for similar or identical items. Specifically, the recommendation module 114 may be configured to review the digital content across different portions of the digital content. For example, the recommendation module 114 may review different web pages included in a web site for duplicate content. The similar or identical items may be highlighted and reported. When reported, a third party may evaluate whether it is effective to maintain the identical items or modify/edit the items.

Additionally, in some embodiments, the recommendation module 114 may be configured to indicate problems and/or corrective recommendations associated with the digital content to a user through the user interface 116. In some embodiments, the recommendation module 114 may indicate the problems and corrective recommendations to a user through the user interface 116. The recommendation module 114 may track the problems and the execution of the corrective recommendation. For example, the recommendation module 114 may receive an indication from a third party when a problem has been corrected. The recommendation module 114 may also receive an indication of an individual or group of individuals that corrected problems. The recommendation module 114 may make the information regarding the execution of the corrective recommendations available to a user through the user interface 116.

Additionally or alternatively, the user interface 116 may provide a list of the problems associated with the digital content. Additionally or alternatively, the user interface 116 may enable a user to visualize the problems and the corrective recommendations inside the digital content. In these and other embodiments, the user interface 116 may present the digital content to a user and an overlay on top of the digital content that indicates the corrective recommendations.

For example, the overlay may have an icon next to or on top of locations in the digital content with problems. The icon may be in the form of an “SEO” button or other mechanism that may display the corrective recommendation. When a user clicks on the icon, the icon may indicate the problem. In some embodiments, when a user interface device, such as a mouse hovers over the icon the problem may be presented to a user. Alternately or additionally, the icon may include text or some other object that indicates locations of problems in the digital content.

In some embodiments, the user interface 116 may provide the information to generate the overlay to another module. For example, a web browser or some other module may have a plugin that receives information from the user interface 116 and allows problems with digital content to be displayed as discussed above through the web browser.

In some embodiments, the recommendation module 114 may implement processes for reviewing digital content analogous to processes for reviewing web pages or web page templates as explained in U.S. patent application Ser. No. 13/648,962 entitled “AUDITING OF WEBPAGES,” filed on Oct. 10, 2012, which application is hereby incorporated by reference in its entirety.

In some embodiments, the recommendation module 114 may be configured to control the release of recommendations regarding the digital content to the third party. In these and other embodiments, before the recommendation module 114 may allow execution of a recommendation, an indication that the changes to the pages have been allowed may need to be received at the recommendation module 114. The recommendation module 114 may also record execution of recommendations and changes resulting therefrom. For example, the recommendation module 114 records an individual or group of individuals that executed the recommendation, the item(s) changed in the digital content, when the recommendation was executed, etc.

In some embodiments, the recommendation module 114 may be configured to send one or more recommendations to an administrator. The administrator may be affiliated with the third party or a content team affiliated with a party operating the SEO system 100. The administrator may have administrative control and oversight over execution of recommendations and recommendation workflows. Additionally the administrator may require or control which of the recommendations are implemented prior to publication or inclusion of an item into digital content. Specifically, the administrator may approve or reject the recommendations, suggest an alternative recommendation, require completion of a recommendation, the administrator may identify recommendations to be executed, the administrator may determine an order in which the recommendations are to be implemented, the administrator may assign recommendations to individual content teams, and/or the administrator may track the status of recommendations.

In some embodiments, recommendations identified in a recommendation workflow may include recommendations to be executed by the SEO system 100 and recommendations to be executed a third party system integrated with the SEO system 100. The recommendation workflow in the SEO system 100 may trigger a corresponding recommendation workflow in the third party system, or vice versa. The corresponding recommendation workflow may enable management and coordination of the execution of the recommendations between the SEO system 100 and the third party and across content teams included therein. The management and coordination of the execution of the recommendations may include a default or customizable policy. For instance, a management policy may include which recommendations are individually executed, which recommendations are automatically executed, recommendations required or recommended to be executed prior to publications, etc.

For example, a recommendation to be performed by a sequence of individuals may be sent to a workflow of a first individual. When the first individual completes her portion of the recommendation, the recommendation may be forwarded to a second individual in the sequence of individuals, etc. The recommendation may be deemed as required prior to publication. Thus, the digital content to which the recommendation applies may be held inactive while the recommendations are executed.

Additionally or alternatively, a recommendation generated by the SEO system 100 may be communicated to a workflow of a CMS. Content teams working on the CMS may then track, execute, and/or close out the recommendations. Additionally individuals, such as content authors, who are responsible for the recommendations or portions thereof may perform the execution and provide feedback to track and/or close out the recommendations.

In some embodiments, an identifier may be assigned to digital content. The identifier may be different when the digital content is published on a network from when the digital content is available in a third party system. Thus, the SEO system 100 may not be able to correlate a published digital content with the digital content in the third party system. In these and other embodiments, the SEO system 100 may include a look-up table that translates the identifier for the digital content that is published with the identifier to the digital content in the third party system. Accordingly, the SEO system 100 may be able to determine where the digital content is located in the third party system and published on a network.

The user interface 116 may be configured to receive and present the SEO data, the digital content, the recommendations, the parameters, the SEO results, or any combination thereof. The user interface 116 may additionally be configured to communicate one or more of the SEO data, the digital content, the recommendations, the parameters, the SEO results, or any combination thereof to the recommendation module 114. The recommendation module 114 may use the SEO data, the digital content, the recommendations, the parameters, the SEO results, or any combination thereof when determining recommendations for additional or future recommendations. By using actual values, the recommendation module 114 may further refine the recommendations.

In some embodiments, the external data may be presented inside or as part of an SEO dashboard (not shown). The SEO dashboard may be included in the user interface 116 in some embodiments. The SEO dashboard may provide a visual representation of the external data using charts, graphs, and other visual representations. Alternately or additionally, the SEO dashboard may present a visual representation of the integration of the collected SEO data and the received external data. The SEO dashboard may track changes over time of the collected SEO data and the received external data as well as issue alerts based on changes of the collected SEO data and the received external data.

FIG. 2 illustrates a system 200 for integrating multiple third party systems (e.g., 240, 220, and 230) with an SEO module 210. In particular, FIG. 2 illustrates an SEO module 210 configured to communicate with a CMS 220, a social media publishing system 230, and a paid media system 240 through the network 102 of FIG. 1.

The social media publishing system 230 may be configured to generate and/or publish social media items. The social media items may include blogs, micro blogs, videos, post, etc. The paid media system 240 may be configured to generate and/or publish paid advertisement in networks such as the Internet. The paid advertisements may include pay-per-click advertisements and other types of advertisements.

The CMS 220 may be configured to generate and/or publish digital content such as web pages. The digital content may be part of a single domain or multiple domains. The digital content may form multiple web sites or be part of a single web site. In some embodiments, the CMS 220 may include digital content templates such as web page templates for individual web pages or for groups of web pages on a web site, as well as multiple web sites, domains, or sub-sites and sub-domains. The CMS 220 may interface with a data storage 250 or a CMS storage 222. The content library may provide the items, such as images, text, videos, among other types of data for integration into the digital content.

Additionally, the CMS 220 may be used in various implementation environments including creation, production, and release of the digital content. For example, the CMS 220 may be used during development or “sandbox” environments, testing environments, certification environments, and pre-production staging environments, as well as full-production, live environments that expose users, such as people searching a network available to the general public (e.g., the internet) to the digital content. Furthermore, in some implementations, a CMS 220 may generate a page with a temporary URL, which may be used for internal purposes before publication. The URL may be subsequently modified or otherwise re-formatted to have an external URL, which may be visible to users and other systems (e.g., the SEO module 210). In some embodiments, the temporary URL may be the identifier assigned to the digital content, which is discussed above. Thus, the temporary URL and the external URL may appear in the look-up table that translates the identifier for the digital content.

In addition, in some implementations, the CMS 220 may be linked to the data storage 250 or the CMS storage 222. The data storage 250 and the CMS storage 222 may store items such as images, product catalog, titles, etc. that may be included in digital content produced by the CMS 220.

The CMS 220, the social media publishing system 230, and the paid media system 240 are examples of third party systems that may be integrated with the SEO module 210 and are not meant to be limiting. Other third party systems might include a web analytics system, a social media network, a social media analytics and metrics system, or some combination thereof, for instance.

In general, each of the third party systems 220, 230, and 240 are configured to communicate with the SEO module 210. Communications between the third party systems 220, 230, and 240 and the SEO module 210 may include communication of third party digital content to the SEO module 210 for analysis, reception of recommendations (discussed below) based on the analysis from the SEO module 210, and reporting of information pertaining to the recommendations to the SEO module 210. The communications between the third party systems 220, 230, and 240 and the SEO module 210 may occur via an API in some embodiments.

The SEO module 210 may include one or more interface modules 212, 214, and 216 (collectively, interface modules) each of which may configured to interface with one or more third party systems 220, 230, and 240. In this and other embodiments, the SEO module 210 includes a social media interface module 212, which may be configured to interface with the social media publishing system 230; a CMS interface module 214, which may be configured to interface with the CMS 220; and a paid media interface module 216, which may be configured to interface with the paid media system 240. The interface modules may be configured to receive third party digital content and reports from the third party systems 220, 230, and 240 and to communicate recommendations based on analysis of the third party digital content to the third party systems 220, 230, and 240.

The third party digital content may vary based on the third party system 220, 230, or 240 in which the third party digital content resides or by which third party system 220, 230, or 240 the third party digital content is controlled. For example, third party digital content from the CMS 220 may include, but is not limited, to pre-published web pages, web page templates, published web pages, published web sites, portions of published web sites, etc. Third party digital content from the paid media system 240 may include published advertisements, advertisements in development, etc.

The SEO module 210 may also include an SEO policy module 132. The SEO policy module 132 may enable definition of an SEO policy. The SEO policy may generally include one or more rules, filters, or criteria that pertain to SEO data and the third party digital content upon which recommendations may be generated. The SEO policy may be established according to a certain number of filters. For instance, an SEO policy may include four, eleven, forty, or more filters that the third party digital content is analyzed against. The SEO policy may, in some embodiments, be a part of or contribute to a centralized policy management system (described above).

The filters may be defined or selected by the third party or may be included as a default provided by an SEO company. The filters may be customized to a specific portion of digital content such as an individual web page or across all digital content of a third party. In some embodiments, a third party may include “flags” in portions of the digital content that indicate with of the filters to apply. Additionally, the filters may include considerations of separate languages, jurisdictional norms, etc. The filters may be selected and modified in a user interface including one or more checklists with the capability to enable or disable the filters at any time.

When an analysis of the third party digital content is performed, the SEO policy may be applied to determine which of the filters are complied with and which are not. This may a “binary” process in which the analysis results in a “yes” or a “no.” For instance, an SEO policy with eleven filters may return a result indicating that only four of the eleven filters are complied with. The recommendations generated by the SEO module 210 relate to bringing the failed filters (i.e., the seven filters in this example) into compliance with the SEO policy.

The SEO module 210 may also include a web analytics module 218. The web analytics module 218 may be configured to collect SEO data and/or other information from the web or other sources pertaining to the third party digital content. The web analytics module 218 may then perform an SEO analysis of the SEO data and/or the third party digital content.

The web analytics module 218 may then communicate the SEO data and the analysis to the interface modules. In some embodiments, the interface modules may apply the SEO policy to the SEO data to analyze the third party digital data. The interface modules may use one or more of the modules described with respect to FIG. 1 in performing the analysis. The interface modules may generate recommendations for the third party systems 220, 230, and 240. Specifically, the interface modules may communicate with the web analytics module 218 and the SEO policy module 132 to analyze the third party digital content in view of the SEO data to generate one or more recommendations regarding the third party digital content. The interface modules may perform the analysis on the third party digital content by applying the SEO policy to the SEO data collected from the Internet. The recommendations generally determine how to better or best optimize SEO objects that may be included in the third party digital content of the third party system 220, 230, and 240.

In some embodiments, the interface modules may locally (i.e., at the SEO module 210) execute the recommendations and push executed recommendations to the third party system 220, 230, and 240. Additionally or alternatively, the interface modules may execute a portion or a subset of the recommendations, push the executed portions or the executed subset of recommendations to the third party systems 220, 230, and 240, while managing the execution by the third party systems 220, 320, and 240 of the remainder of the recommendations for remote (i.e., at the third party systems 220, 230, and 240) execution. Additionally or alternatively, the interface modules may manage the recommendations to determine which of the recommendations have been remotely executed.

The third party systems 220, 230, and 240 may communicate one or more reports to the interface modules indicating which of the recommendations have been remotely executed and SEO results of the recommendations. The SEO results may include progress or status of recommendations, inability to complete recommendations, impact on SEO metrics due to execution, timelines regarding status or expected completion, etc. In some embodiments, the interface modules may additionally or alternatively be configured to estimate the SEO results and to communicate the SEO results to the third party system 220, 320, or 240 or a user.

In some embodiments, the recommendations may be communicated to one or more of the third party systems 220, 320, or 240. At the third party systems 220, 230, and 240, the recommendations may be proposed to the third party and executed subject to the approval or adjustment of the third party and/or the third party system 220, 230, or 240.

In some embodiments, the interface modules may additionally or alternatively be configured to control execution of the recommendations. For example, the third party systems 220, 230, or 240 may not be able to complete a certain recommendation until an interface module receives an instruction to proceed. Another example may include a generalized recommendation that requires later approval by the interface modules.

In some embodiments, the interface modules may additionally or alternatively be configured to determine metrics relevant to the SEO policy and/or the third party digital content. For example, the social media interface module 212 may be configured to determine social media metrics relevant to the third party digital content controlled by the social media publishing system 230.

For example, the CMS 220 may be configured to receive the recommendations from the CMS interface module 214 and to set the recommendations in action. The CMS module 220 may send results back to the CMS interface module 214 regarding the status of the recommendations. The SEO results may be sent to the CMS interface module 214 once the recommendations have been assigned, completed, opened longer than a predetermined period, closed-out, etc. The CMS interface module 214 may summarize the recommendations and provide a report regarding the recommendations to a user. The report regarding the recommendations may include an expected impact of the completion or non-completion of the recommendations, a time period the recommendations took to complete, among other information.

In some embodiments, the CMS 220 may not be able to complete certain recommendations until the CMS 220 reports to the CMS interface module 214 and receives an instruction to proceed from the CMS interface module 214. For example, the CMS 220 may determine changes to make to a web site. The changes may not be implemented until the CMS interface module 214 approves the changes to the web site.

As depicted in FIG. 2, the analysis of the third party digital content occurs at the SEO system 100. However, this is not meant to be limiting, in some alternative embodiments, the analysis of the third party digital content occurs in one or more of the third party system 220, 230, and 240.

In addition to analyzing the third party digital content to generate recommendations, the third party digital content may be analyzed to detect a pattern in two or more recommendations. The pattern may include an association between a specific third party digital content template or a type of third party digital content template, a whole section of web sites, a specific content team, a sub-domain, a type of tag, a title, or third party digital content with a specific problem. The specific problem which continues to be generate a duplicate recommendation may indicate a larger problem with digital content or that a problem exists in the digital content across multiple domains, web sites, content teams, etc. Thus, by detecting the pattern in two or more recommendations, a recommendations regarding the specific problem may be generated that may be applied to the multiple domains, web sites, etc.

The SEO module 210 may include some of the aspects of the SEO system 100 of FIG. 1. For example, the SEO module 200 may include a correlator 104, a deep index engine 108, a receiving module 112, a recommendation module 114, a user interface 116, an optimization module 120, and a sending module 130. For example, one or more of these components may be integrated into the interface modules, the web analytics module 218, the SEO policy module 132, or may be an independent module in communication with the interface modules, the web analytics module 218, or the SEO policy module 132.

The interface modules of the SEO module 210 may share information and may collaborate when issuing recommendations to the third party systems 220, 230, and 240. Accordingly, the third party digital content third party systems 220, 230, and 240, may be controlled at least regarding execution of the recommendations by the SEO module 210. By being controlled by the SEO module 210, the third party digital content may show increased collaboration and better SEO results than a similar third party system(s) controlled independently or without the SEO module 210.

In some embodiments, the SEO module 210 may also act as an interface between the CMS module 220, the social media publishing module 230, and the paid media module 240. For example, the CMS module 220 may provide recommendations and/or information to the paid media module 240 or the social media publishing module 230. Here the recommendations may be routed through the SEO module 210, allowing the SEO module 210 to provide the interface between these different systems.

Additionally, the system 200 may include an external data source 260. In some embodiments, the SEO module 210 may analyze content included in the external content sources 260. The external content sources 260 may include word documents, third party documents, documents publically available, products catalogs, etc. Bulk digital content may be received from the external content sources 260. For example, bulk digital content such as web pages may be generated or auto-generated by an automatic service and directly submitted to the SEO module 210. The SEO module 210 may perform an analysis of the bulk digital content may be performed based on the SEO policy and recommendations may be generated based on the analysis. The performance of the analysis on the bulk digital content may enable capture of problems before the bulk digital content is integrated into published third party digital content.

An embodiment of the system 200 may include a thin-client plugin. The thin-client plugin may be embedded in or integrated with code of a third party system. A thin-client plugin could coordinate communication and pass data between a CMS system and an SEO system, commonly by utilizing application interfaces for each system. The thin-client plugin may thus enable analysis of third party digital content or any portion thereof through an action performed at the third party during operation of the third party system. The thin-client plugin may further enable and facilitate communication between the third party system, the SEO module 210 and/or a social network system. The communication enabled by the thin-client plugin may be such that data (e.g., recommendations, analysis results, etc.) communicated to one of the systems (e.g., the third party system or the SEO system) is displayed or otherwise accessible by one or more other systems. The display and accessibility of the data may allow an action to be taken in one of the systems and be consequently reflected in the other systems.

Furthermore, a thin-client plugin designed to manage communication and data transfer between systems rather than instead embedding a full-feature SEO system directly inside a CMS 220, may be more flexible than a thick-client solution. The thin-client plugin may manage fewer functions and may allow the two systems to operate more independently. Thus, a thin-client solution may make it more feasible, for example, to change SEO policies in an SEO module 210 rapidly and in a timely manner without requiring extensive changes to the code-base of the CMS system that manages digital content for a web site.

For example, an individual working on the CMS 220 may complete a version of a web page or group of web pages. Prior to publication, the individual may select to have the web page or group of pages analyzed by the SEO module 210. The individual may take an action such as selecting an icon or pushing a button in the UI of the CMS system, for instance, that indicates the individual wishes an analysis of the page or groups of pages be conducted.

Digital content and data about the web page or group of pages may be forwarded from the CMS 220 to the SEO module 210 where an analysis of the content and data may be performed. In some embodiments, the thin-client plugin may include an encryption/decryption functionality to ensure the third party digital content is not compromised during the communication.

The analysis may then be performed based on an SEO policy set up by the third party in control of the CMS 220 and/or the SEO module 210. In some implementations, the individual may select to analyze a portion of the web site and may select a second portion of the web site not to be analyzed or analyzed by a second set of filters in the SEO policy. The analysis may accordingly be performed on each of the web pages included in the web site or to each of the web pages selected by the individual to be analyzed.

The SEO policy may include one or more filters applied as criteria according to which the analysis is performed. The SEO module 210 applies the SEO policy to determine which of the filters the web site or portion thereof complies with and which of the filters the web site or portion thereof fails to meet. For instance, an SEO policy may include some number of specific filters. For illustrative purposes a particular implementation may include eleven filters. During the analysis it may be determined that the web site or one or more specific web pages fail four of the eleven filters. The SEO module 210 then generates recommendations based on the failed filters. Like the analysis, the recommendations may be web page specific or web site specific. Thus, the recommendations may pertain only to a single web page that failed one or more of the filters or may generally apply to the entire web site.

The SEO module 210 may then communicate the results of the analysis (i.e., failure of four of the eleven filters), any analysis related thereto (e.g., an impact of a failure as high, med, or low, etc.) and/or the recommendations to the CMS 220. In this and other embodiments, one or more of the results, the analysis related thereto or the recommendations may be optionally viewed. For instance, the individual may have the option to select a “tell me more” icon to receive one or more information, explanation, or other data about the filter or the specific results, the analysis related thereto or the recommendations. Additionally, the “tell me more” may include detailed explanations of the results, the analysis related thereto or the recommendations and provide a link to a deep knowledge base about the filter, the recommendation, or the analysis applied by the SEO policy to the page or web site.

At the CMS 220, the individual may choose to view the failed filters, analysis related thereto, and/or the recommendations. The failed filters, the analysis thereof, and/or the recommendations may be viewed in a drop-down menu in a user interface, for instance. Additionally or alternatively, the failed filters, the analysis thereof, and/or the recommendations may be communicated to a supervisory administrator. The administrator and/or the individual may enable the recommendations to enter into content group workflows, may select one or more of the recommendations as benchmarks prior to publication, may prioritize implementation of certain recommendations, may generate reports based on the results or recommendations, which may be communicate throughout a third party and/or to the SEO module 210.

Execution of the recommendations may be automatically communicated to the SEO module 210 and/or throughout the third party that controls the CMS 220. This tracking of execution of the recommendations may feed back into workflows, priorities lists, benchmark management, etc. to ensure the recommendations are executed as managed by the SEO module 210 in conjunction with the third party.

Following execution of one or more of the recommendations, the SEO module 210 may track revenue or SEO results stemming from execution of the recommendations. For example, inclusion of a particular keyword may be one of the recommendations. When executed, the keyword may be monitored for search results that lead clients to the web page. The SEO results may be communicated to the third party in control of the CMS 220 or may lead to additional recommendations, for instance.

The thin-client SEO plugin for a CMS system may facilitate driving recommendations into digital content publishing earlier in authoring processes, specifically prior to publishing on a production web site, rather than necessitating performing edits to digital content to improve SEO performance after the fact, ie., downstream from the date the digital content is pushed into production on a web site. This enables commercial entities to initially and/or on an on-going basis generate more effective and optimized digital content for their web sites much earlier in the content and publishing cycle and thus avoiding missing end-user conversion events and losing valuable on-line revenue.

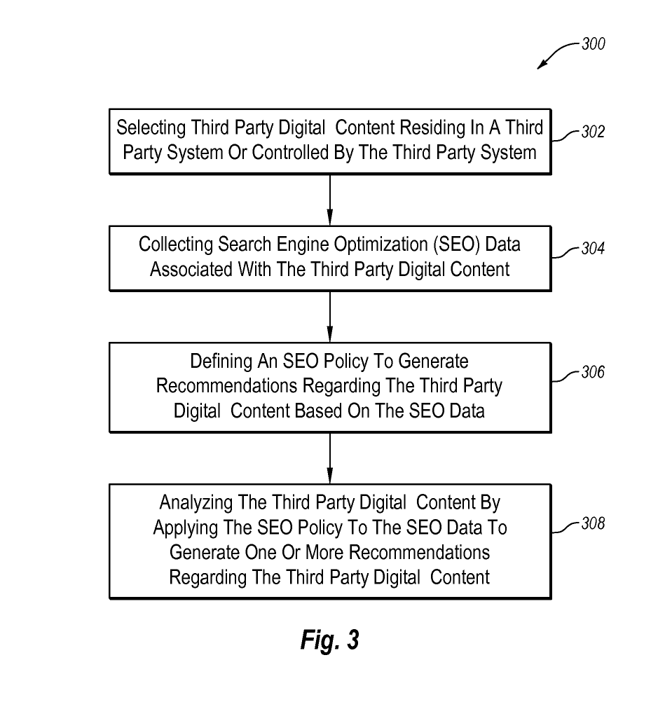

FIG. 3 is a flow chart of an example method 300 of managing digital content in accordance with at least some embodiments described herein. The method 300 may be implemented, in some embodiments, by an SEO system, such as the SEO system 100 of FIG. 1. For instance, the recommendation module 114 within the SEO system 100 of FIG. 1 may be configured to execute computer instructions to cause the SEO system 100 to perform operations for managing digital content as represented by one or more of blocks 302, 304, 306, and, 308 of the method 300. Although illustrated as discrete blocks, various blocks may be divided into additional blocks, combined into fewer blocks, or eliminated, depending on the desired implementation.

The method 300 may begin at 302 by selecting third party digital content residing in a third party system or controlled by the third party system. In some embodiments, the third party system may include a CMS, a web analytics system, a social media network, a social media publishing system, a social media analytics and metrics system, or a paid media system.

At 304, the method 300 may include collecting SEO data associated with the third party digital content. At 306, the method 300 may include defining an SEO policy to generate recommendations regarding the third party digital content based on the SEO data. In some embodiments, the SEO policy may be customized based on the type of third party digital content.

At 306, the method 300 may include analyzing the third party digital content by applying the SEO policy to the SEO data to generate one or more recommendations regarding the third party digital content. The recommendations may be generated in real-time or near real-time and/or may be generated at one or more times as the third party digital content is being developed. For example, the recommendations may be generated without direct user interaction once the third party digital content is published.

For example, the SEO policy may be defined to include a criterion that the third party digital content appears in the first twenty search results for a commercial search using a particular keyword. SEO data may be collected using a deep index engine regarding the particular keyword and search results using the particular keyword. If the third party digital content does not appear in the first twenty search results, then recommendations regarding the third party digital content may be generated to move the third party digital content into the first twenty results. As the third party digital content is modified or edited, the deep index engine may continue to collect SEO data regarding the search results using the particular keyword of the third party digital content. When the SEO data indicates the third party digital content appears outside of the first twenty search results, recommendations may be generated to place the third party digital content in the top twenty search results. Additionally, when a third party may re-defines the criterion to ensure the third party digital content appears in the first ten search results, recommendations may be generated to move the third party digital content into the first ten search results.

In some embodiments, the recommendations may triggered automatically, through selection of an object shown on-screen in a drop-down menu, or through selection of an on-screen recommendation button being a selectable feature in the third party system. Additionally or alternatively, one or more of the recommendations may be generated according to a third party system template.

The method 300 may further include prioritizing the recommendations based on one or more parameters. The parameters may include but are not limited to a corporate policy, a best practice, an estimated search result, an actual search result, a social engagement metric, or a desired financial result.

In some embodiments, analyzing the third party digital content occurs in the third party system. Additionally or alternatively, analyzing the third party digital content may occur differently in different implementation environments. The different implementation environments may include a sandbox environment, a test environment, a development environment, a certification environment, a qualification environment, a pre-production environment, or a live production environment accessible to users.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, the method 300 may include estimating a financial or optimization result of the third party executing one or more of the recommendations.

Additionally or alternatively, the method 300 may include pushing the recommendations to the third party system, managing the recommendations to determine which of the recommendations to execute at the third party, and tracking financial or optimization results achieved by executing the recommendations.

Additionally or alternatively, the method 300 may include consolidating multiple SEO policies such that the consolidated SEO policies constitute a centralized policy management solution.

In some embodiments, the method 300 may include receiving parameters associated with the third party digital content. In these and other embodiments, analyzing the third party digital content may include applying the SEO policy to the parameters.

In some embodiments, the method 300 may include executing at an SEO system the recommendations. When the recommendations are executed, the executed recommendations may be pushed to the third party system. In these and other embodiments, pushing the executed recommendations may be without any intervention by the third party system or users of the third party system.

Additionally or alternatively, the method 300 may include communicating the recommendations to the third party system. At the third party system, the recommendations may be proposed to the third party and executed subject to the approval or adjustment of the third party.

In some embodiments, the method 300 may include presenting an overlay on top of the third party digital content. The overlay may indicate problems of the third party digital data and recommendations regarding the third party digital content.

Additionally or alternatively, the method 300 may include analyzing multiple third party digital contents to detect duplicative items across different third party digital contents. When detected, the duplicative items may be highlighted and evaluated by the third party.

Additionally or alternatively, the method 300 may include analyzing the third party digital content to detect a pattern in two or more recommendations. The pattern may include an association between a specific third party digital content template or a type of third party digital content template, a whole section of web sites, a specific editorial team, a sub-domain, a type of tag, a title, or a third party digital content with a specific problem.

Some embodiments described herein include a computer program product having computer-executable instructions for causing a computing system having the computer program product to perform a computing method of the computer-executable instructions for managing digital content. The computing method may be any method described herein as performed by a computing system. The computer program product may be located on a computer memory device, which may be removable or integrated with the computing system.

Some embodiments described herein include a computing system capable of performing the methods described herein. As such, the computing system may include a memory device that has the computer-executable instructions for performing the method.

In some embodiments, a computing device, such as a computer or memory device of a computer, may include one or more modules or systems discussed with reference to FIGS. 1 and 2. These modules may be configured to perform any of the methods described herein. In addition, these modules may be combined into a single module or on a single platform. In some embodiments, a computer program product may include one or more algorithms for performing any of the methods of any of the claims.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for describing particular embodiments only, and is not intended to be limiting.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

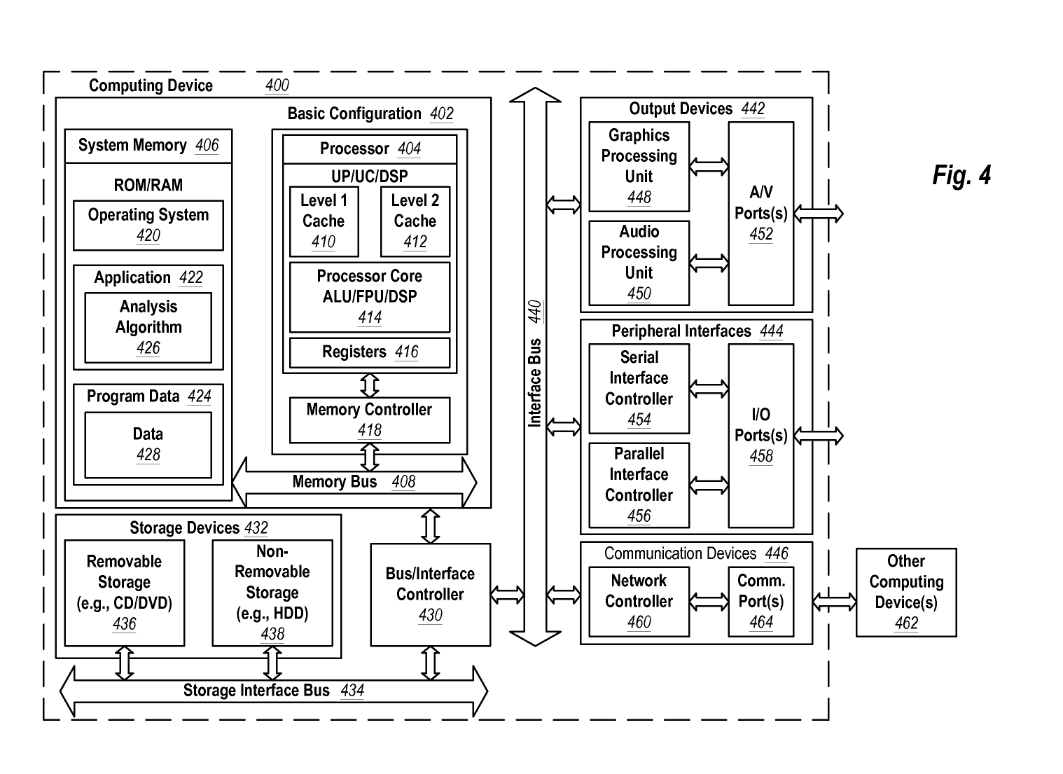

FIG. 4 shows an example computing device 400 that is arranged to perform any of the computing methods described herein. In a very basic configuration 402, computing device 400 generally includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating-point unit (FPU), a digital signal-processing core (DSP Core), or any combination thereof. An example memory controller 418 may also be used with processor 404, or in some implementations, memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include an analysis algorithm 426 that is arranged to perform the functions as described herein including those described with respect to methods described herein. The analysis algorithm 426 may correspond to the recommendation module 114 of FIG. 1, for example. Program data 424 may include data 428, such as SEO data, parameters, SEO results, etc. that may be useful for generating recommendations for digital content. In some embodiments, application 422 may be arranged to operate with program data 424 on operating system 420.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436, and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations. The computing device 400 may also be any type of network computing device. The computing device 400 may also be an automated system as described herein.

The embodiments described herein may include the use of a special purpose or general-purpose computer including various computer hardware or software modules. Embodiments within the scope of the present invention also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data that cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” and the like include the number recited and refer to ranges which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

What is claimed is:

1. A method of managing digital content, the method comprising:
selecting third party digital content residing in a third party system or controlled by the third party system;
collecting search engine optimization (SEO) data associated with the third party digital content;
defining an SEO policy to generate recommendations regarding the third party digital content based on the SEO data; and
analyzing the third party digital content by applying the SEO policy to the SEO data to generate one or more recommendations regarding the third party digital content.

2. The method of claim 1, wherein the recommendations include one or more of: include identifying an SEO object to generate or publish in the third party digital content; identifying when or how to generate an SEO object in the third party digital content; identifying when or how to publish an SEO object in the third party digital content; identifying where to publish an SEO object in the third party digital content; identifying which SEO objects are trending in which social media channels or on a network related to the third party digital content; identifying which SEO objects are valuable in which social media channels or on a network related to the third party digital content; determining an impact of an SEO object on search volume directed towards the third party digital content, search traffic directed towards the third party digital content, or web analytics metrics directed towards the third party digital content; suggesting a choice about which SEO objects to focus a campaign of involving the third party digital content for maximum SEO; determining a way to optimize a campaign involving the third party digital content for multiple keywords; producing a backlink to the third party digital content; changing items of the third party digital content; changing a tag within the third party digital content; using items for the third party digital content related to a certain demographic; searching at a predetermined frequency for a keyword that leads users to the third party digital content; identifying a change to layout of the third party digital content; identifying a change of a code-to-text ratio of the third party digital content; suggesting a change to a presence of images in the third party digital content; identifying an alternative tag to include in the third party digital content; identifying duplicate items on various third party digital content; identifying competitive information related to the third party digital content; identifying keyword optimizations for the third party digital content; identifying keyword-page associations for the third party digital content; and identifying web site priorities for certain keyword-page associations of one type over other keyword page associations included in the third party digital content.

3. The method of claim 1, wherein defining the SEO policy includes:
defining a filter for a first portion of the third party digital content, the filter being customizable according to one or more of a group of users, a domain, and a set of domains; and
incorporating a flag into the first portion of the third party digital content such that the first portion of the third party digital content is detectable during an analysis;

4. The method of claim 1, further comprising estimating a financial result or optimization result of the third party executing one or more of the recommendations.

5. The method of claim 1, further comprising:
pushing the recommendations to the third party system;
managing the recommendations to determine which of the recommendations to execute at the third party; and
tracking financial or optimization results achieved by executing the recommendations.

6. The method of claim 1, wherein the third party system includes a content management systems (CMS), a web analytics system, a social media network, a social media publishing system, a social media analytics and metrics system, or a paid media system.

7. The method of claim 1, further comprising consolidating multiple SEO policies such that the consolidated SEO policies constitute a centralized policy management solution.

8. The method of claim 1, further comprising prioritizing the recommendations based on one or more parameters, the parameters including a corporate policy, a best practice, an estimated search result, an actual search result, a social engagement metric, or a desired financial result.

9. The method of claim 1, wherein:
the recommendations are triggered automatically, through selection of an object shown on-screen in a drop-down menu, or through selection of an on-screen recommendation button being a selectable feature in the third party system; and
the recommendations are generated in real-time or near real-time.

10. The method of claim 1, further comprising:
receiving bulk digital content from an external content source, the bulk digital content being generated automatically;
analyzing the bulk digital content according to the SEO policy;
generating recommendations pertaining to the bulk digital content.

11. The method of claim 1, wherein:
the recommendations are generated one or more times as the third party digital content is being developed; and
the recommendations are generated without direct user interaction once the third party digital content is published.

12. The method of claim 1, further comprising receiving parameters associated with the third party digital content and wherein analyzing the third party digital content includes applying the SEO policy to the parameters.

13. The method of claim 1, further comprising:
executing at an SEO system the recommendations; and
pushing executed recommendations to the third party system, wherein pushing the executed recommendations is without any intervention by the third party system or users of the third party system.

14. The method of claim 1, further comprising communicating the recommendations to the third party system, wherein the recommendations are proposed to the third party and executed subject to the approval or adjustment of the third party.

15. The method of claim 1, wherein one or more of the recommendations are generated according to a third party system template.

16. The method of claim 1, further comprising presenting an overlay on top of the third party digital content, the overlay indicating problems of the third party digital data and recommendations regarding the third party digital content.

17. The method of claim 1, wherein analyzing the third party digital content occurs in the third party system.

18. The method of claim 1, wherein analyzing the third party digital content occurs differently in different implementation environments, the different implementation environments including a sandbox environment, a test environment, a development environment, a certification environment, a qualification environment, a pre-production environment, or a live production environment accessible to users.

19. The method of claim 1, further comprising analyzing a plurality of third party digital contents to detect duplicative items across different third party digital contents, wherein the duplicative items are highlighted and evaluated.

20. The method of claim 1, further comprising analyzing the third party digital content to detect a pattern in two or more recommendations, the pattern including an association between a specific third party digital content template or a type of third party digital content template, a whole section of web sites, a specific editorial team, a sub-domain, a type of tag, a title, or a third party digital content with a specific problem.
